(19) United States
(12) Patent Application Publication
(10) Pub. No.: US 2013/0346465 A1
(43) Pub. Date: Dec. 26, 2013

(54) APPLICATION ENHANCEMENT USING EDGE DATA CENTER

(71) Applicants: David A. Maltz, Bellevue, WA (US); Parveen Patel, Redmond, WA (US); Albert G. Greenberg, Seattle, WA (US); Srikanth Kandula, Redmond, WA (US); Nick Holt, Seattle, WA (US); Randall Friend Kern, Seattle, WA (US)

(72) Inventors: David A. Maltz, Bellevue, WA (US); Parveen Patel, Redmond, WA (US); Albert G. Greenberg, Seattle, WA (US); Srikanth Kandula, Redmond, WA (US); Nick Holt, Seattle, WA (US); Randall Friend Kern, Seattle, WA (US)

(73) Assignee: MICROSOFT CORPORATION, Redmond, WA (US)

(21) Appl. No.: 13/530,036

(22) Filed: Jun. 21, 2012

(51) Int. Cl. G06F 15/16

(52) U.S. Cl. 709/201

(57) ABSTRACT

A management service that receives requests for the cloud computing environment to host applications, and improves performance of the application using an edge server. In response to the original request, the management service allocates the application to run on an origin data center, evaluates the application by evaluating at least one of the application properties designated by an application code author or provider, or the application performance, and uses an edge server to improve performance of the application in response to evaluating the application. For instance, a portion of application code may be offloaded to run on the edge data center, a portion of application data may be cached at the edge data center, or the edge server may add functionality to the application.

### BACKGROUND

“Cloud computing” is a model for enabling ubiquitous, convenient, on-demand network access to a shared pool of configurable computing resources (e.g., networks, servers, storage, applications, and services). The shared pool of configurable computing resources can be rapidly provisioned via virtualization and released with low management effort or service provider interaction, and then scaled accordingly. A cloud computing model can be composed of various characteristics (e.g., on-demand self-service, broad network access, resource pooling, rapid elasticity, measured service, etc), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.). An environment that implements the cloud computing model is often referred to as a cloud computing environment.

A cloud computing environment may include a number of data centers, each having computing resources such as processing power, memory, storage, bandwidth, and so forth. Some of the data centers are larger and may be referred to as origin data centers. Origin data centers may be distributed throughout the globe. The cloud computing environment may also have a larger number of smaller data centers, referred to as “edge data centers” also distributed through the globe. In general, for a given network location, a client entity (e.g., a client computing system or its user) is often a lot closer geographically and closer from a network perspective (in terms of lower latency) to an edge data center than to an origin data center.

### BRIEF SUMMARY

At least one embodiment described herein relates to the improved performance of a cloud computing environment using an edge data center. A cloud computing environment includes larger origin data centers, and smaller, but more numerous, edge data centers. A management service receives requests for the cloud computing environment to host applications. In response, the management service allocates the application to run on an origin data center, evaluates the application by evaluating at least one application property specified by a provider of application code corresponding to the application or evaluating runtime performance of the application, and uses an edge server to improve performance of the application in response to evaluating the application. As examples only, a portion of application code may be offloaded to run on the edge data center, a portion of application data may be cached at the edge data center, and/or the edge server may add functionality to the application.

This Summary is not intended to identify key features or essential features of the claimed subject matter, nor is it intended to be used as an aid in determining the scope of the claimed subject matter.

### BRIEF DESCRIPTION OF THE DRAWINGS

In order to describe the manner in which the above-recited and other advantages and features can be obtained, a more particular description of various embodiments will be rendered by reference to the appended drawings. Understanding that these drawings depict only sample embodiments and are not therefore to be considered to be limiting of the scope of the invention, the embodiments will be described and explained with additional specificity and detail through the use of the accompanying drawings in which:

FIG. 1 illustrates a computing system in which some embodiments described herein may be employed;

FIG. 2 abstractly illustrates cloud computing environment in which the principles described herein may operate, and includes multiple services, and multiple data centers;

FIG. 3 illustrates a flowchart of a method for enhancing the performance of an application operating in a cloud computing environment;

FIG. 4 abstractly illustrates a request for a cloud computing environment to host an application;

FIG. 5 illustrates an environment in which an edge data center intermediates between a client entity and an application running on an original data center;

FIG. 6 illustrates an environment in which application code is offloaded from an origin data center to an edge data center to enhance performance of the application;

FIG. 7 illustrates an environment in which application data is cached by an edge data center to enhance performance of the application running on the origin data center;

FIG. 8 illustrates an environment in which performance of the application on the origin server is enhanced by a component on the edge data center; and

FIG. 9 illustrates an environment in which there are three or more tiers of data centers operating to improve performance of an application for a client entity.

### DETAILED DESCRIPTION

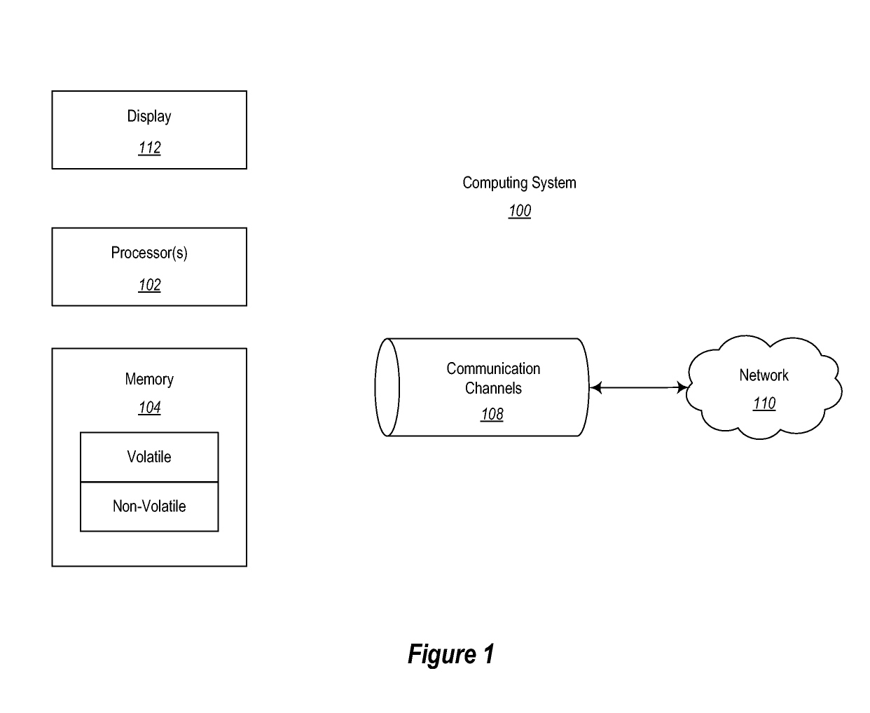

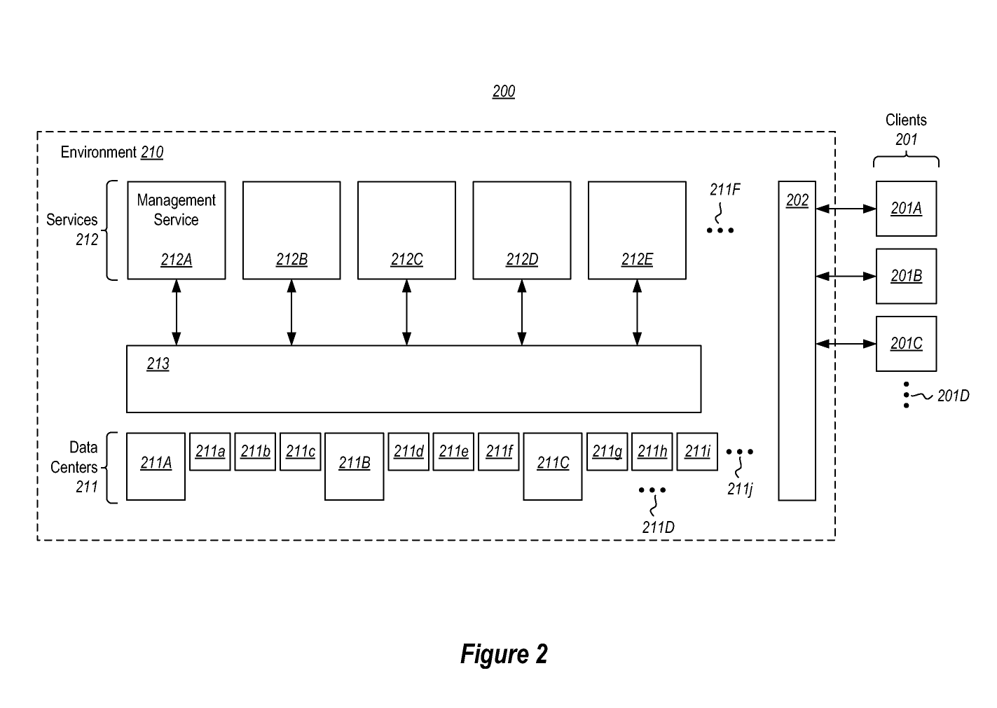

In accordance with embodiments described herein, a management service receives requests for the cloud computing environment to host applications. In response, the management service allocates the application to run on an origin data center, evaluates the application by evaluating at least one application property specified by a provider of application code corresponding to the application or evaluating runtime performance of the application, and uses an edge server to improve performance of the application in response to evaluating the application. As examples only, a portion of application code may be offloaded to run on the edge data center, a portion of application data may be cached at the edge data center, or the edge server may add functionality to the application. First, some introductory discussion regarding computing systems will be described with respect to FIG. 1. Then, embodiments of the management service will be described with respect to FIGS. 2 through 9.

Computing systems are now increasingly taking a wide variety of forms. Computing systems may, for example, be handheld devices, appliances, laptop computers, desktop computers, mainframes, distributed computing systems, or even devices that have not conventionally been considered a computing system. In this description and in the claims, the term “computing system” is defined broadly as including any device or system (or combination thereof) that includes at least one physical and tangible processor, and a physical and tangible memory capable of having thereon computer-executable instructions that may be executed by the processor. The memory may take any form and may depend on the nature and form of the computing system. A computing system may be distributed over a network environment and may include multiple constituent computing systems.

As illustrated in FIG. 1, in its most basic configuration, a computing system 100 typically includes at least one processing unit 102 and memory 104. The memory 104 may be physical system memory, which may be volatile, non-volatile, or some combination of the two. The term “memory” may also be used herein to refer to non-volatile mass storage such as physical storage media. If the computing system is distributed, the processing, memory and/or storage capability may be distributed as well. As used herein, the term “module” or “component” can refer to software objects or routines that execute on the computing system. The different components, modules, engines, and services described herein may be implemented as objects or processes that execute on the computing system (e.g., as separate threads).

In the description that follows, embodiments are described with reference to acts that are performed by one or more computing systems. If such acts are implemented in software, one or more processors of the associated computing system that performs the act direct the operation of the computing system in response to having executed computer-executable instructions. An example of such an operation involves the manipulation of data. The computer-executable instructions (and the manipulated data) may be stored in the memory 104 of the computing system 100. Computing system 100 may also contain communication channels 108 that allow the computing system 100 to communicate with other message processors over, for example, network 110.

Embodiments described herein may comprise or utilize a special purpose or general-purpose computer including computer hardware, such as, for example, one or more processors and system memory, as discussed in greater detail below. Embodiments described herein also include physical and other computer-readable media for carrying or storing computer-executable instructions and/or data structures. Such computer-readable media can be any available media that can be accessed by a general purpose or special purpose computer system. Computer-readable media that store computer-executable instructions are physical storage media. Computer-readable media that carry computer-executable instructions are transmission media. Thus, by way of example, and not limitation, embodiments of the invention can comprise at least two distinctly different kinds of computer-readable media: computer storage media and transmission media.

Computer storage media includes RAM, ROM, EEPROM, CD-ROM or other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry or desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to computer storage media (or vice versa). For example, computer-executable instructions or data structures received over a network or data link can be buffered in RAM within a network interface module (e.g., a “NIC”), and then eventually transferred to computer system RAM and/or to less volatile computer storage media at a computer system. Thus, it should be understood that computer storage media can be included in computer system components that also (or even primarily) utilize transmission media.

Computer-executable instructions comprise, for example, instructions and data which, when executed at a processor, cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

FIG. 2 abstractly illustrates an environment 200 in which the principles described herein may be employed. The environment 200 includes multiple clients 201 interacting with a cloud computing environment 210 using an interface 202. The environment 200 is illustrated as having three clients 201A, 201B and 201C, although the ellipses 201D represent that the principles described herein are not limited to the number of clients interfacing with the cloud computing environment 210 through the interface 202. The cloud computing environment 210 may provide services to the clients 201 on-demand and thus the number of clients 201 receiving services from the cloud computing environment 210 may vary over time.

Each client 201 may, for example, be structured as described above for the computing system 100 of FIG. 1. Alternatively or in addition, the client may be an application or other software module that interfaces with the cloud computing environment 210 through the interface 202. The interface 202 may be an application program interface that is defined in such a way that any computing system or software entity that is capable of using the application program interface may communicate with the cloud computing environment 210.

Cloud computing environments may be distributed and may even be distributed internationally and/or have components possessed across multiple organizations. In this description and the following claims, “cloud computing” is defined as a model for enabling on-demand network access to a shared pool of configurable computing resources (e.g., networks, servers, storage, applications, and services). The definition of “cloud computing” is not limited to any of the other numerous advantages that can be obtained from such a model when properly deployed.

For instance, cloud computing is currently employed in the marketplace so as to offer ubiquitous and convenient on-demand access to the shared pool of configurable computing resources. Furthermore, the shared pool of configurable computing resources can be rapidly provisioned via virtualization and released with low management effort or service provider interaction, and then scaled accordingly.

A cloud computing model can be composed of various characteristics such as on-demand self-service, broad network access, resource pooling, rapid elasticity, measured service, and so forth. A cloud computing model may also come in the form of various service models such as, for example, Software as a Service (“SaaS”), Platform as a Service (“PaaS”), and Infrastructure as a Service (“IaaS”). The cloud computing model may also be deployed using different deployment models such as private cloud, community cloud, public cloud, hybrid cloud, and so forth. In this description and in the claims, a “cloud computing environment” is an environment in which cloud computing is employed.

The system 210 includes multiple data centers 211, each including corresponding computing resources, such as processing, memory, storage, bandwidth, and so forth. The data centers 211 include larger origin data centers 211A, 211B and 211C, though the ellipses 211D represent that there is no restriction as to the number of origin data centers within the data center group 211. Also, the data centers 211 include smaller edge data centers 211a through 211i, although the ellipses 211j represent that there is no restriction as to the number of edge data centers within the data center group 211. Each of the data centers 211 may include perhaps a very large number of host computing systems that may be each structured as described above for the computing system 100 of FIG. 1.

The data centers 211 may be distributed geographically, and perhaps even throughout the world if the cloud computing environment 200 spans the globe. The origin data centers 211A through 211D have greater computing resources, and thus are more expensive, as compared to the edge data centers 211a through 211j. Thus, there are a smaller number of origin data centers distributed throughout the coverage of the cloud computing environment 200. The edge data centers 211 have lesser computing resource, and thus are less expensive. Thus, there is a larger number of edge data centers distributed throughout the coverage of the cloud computing environment 200. Thus, for a majority of clients 201, it is more likely that the client entity (e.g., the client machine itself or its user) is closer geographically and closer from a network perspective (in terms of latency) to an edge data center as compared to an origin data center.

The cloud computing environment 200 also includes services 212. In the illustrated example, the services 200 include five distinct services 212A, 212B, 212C, 212D and 212E, although the ellipses 212F represent that the principles described herein are not limited to the number of service in the system 210. A service coordination system 213 communicates with the data centers 211 and with the services 212 to thereby provide services requested by the clients 201, and other services (such as authentication, billing, and so forth) that may be prerequisites for the requested service.

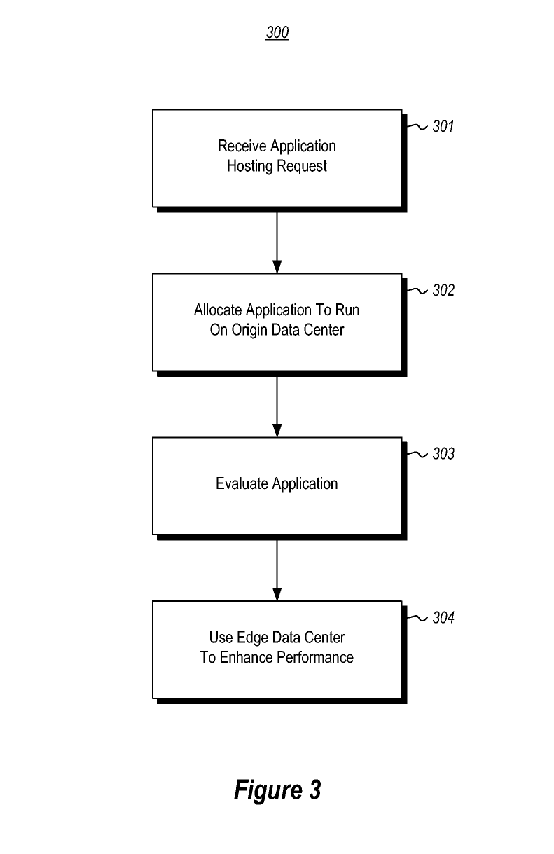

One of the services 212 (e.g., service 212A) may be a management service that is described in further detail below, and that operates to deploy and operating an application in the cloud computing environment in a manner that performance of the application is enhanced. FIG. 3 illustrates a flowchart of a method 300 for enhancing the performance of an application operating in a cloud computing environment. As the method 300 may be performed by the management service 212A of FIG. 2, the method 300 will now be described with reference to the cloud computing environment 200 of FIG. 2.

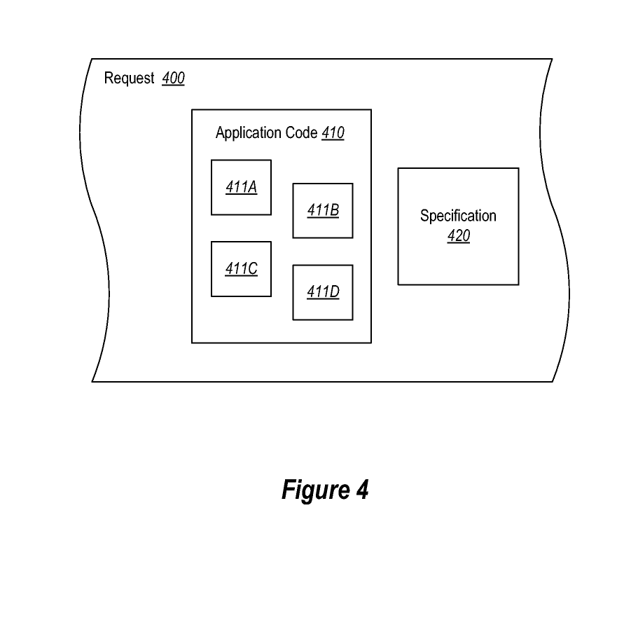

The method 300 is performed in response to receiving a request for the cloud computing environment to host an application (act 301). The request may come with the application code itself, as well as a description of the structure and dependencies of the application and its constituent components. For example, FIG. 4 illustrates the request 400 as abstractly including the application code 410, which includes constituent components 411A, 411B, 411C and 411D. The request 400 also includes a specification 420 that describes the constituent components and the dependencies of the application code 410 and the constituent components. The specification 420 may also include attributes or properties of the application declared by the application code 410 author or provider. These can include hints as to a desired configuration or deployment, or a configuration or deployment that the author or provider believes to be beneficial. For instance, with reference to FIG. 2, an example will be referenced hereinafter as a “reference example” in which the client 201A issues a request (such as request 400) to the management service 212A (via the interface 202 and service coordination system 213) to have the cloud computing environment 210 host an application (such as application 410). The request 400 need not be communicated all at once to the management service 212A, but may be communicated over several distinct communications.

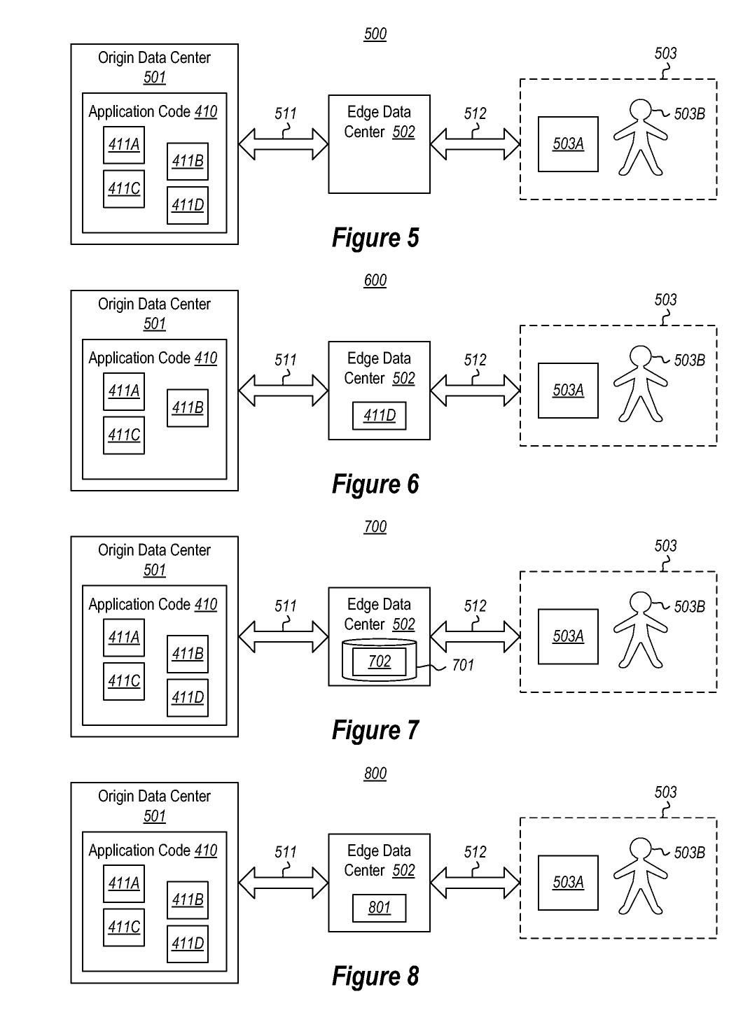

The management service then responds by allocating the application to run on an origin data center (act 302). For instance, suppose in the reference example, that the management service 212A responds to the request from the client 201A by allocating the application to run on the origin data center 211A. FIG. 5 abstractly illustrates, an environment 500 in which application 410 (with its constituent components is allocated to run on an origin data center 501 (which is the origin data center 211A in the reference example). To complete the environment 500, the origin data center 501 communicates with an edge data center 502 over a channel 511. The edge data center 502 communicates with the client entity 503 over another channel 512. The client entity 503 comprises the client machine 503A (e.g., client 201A in the reference example) and/or its user 503B.

Returning to FIG. 3, the management service then evaluates the application (act 303) by evaluating at least one of the application properties or attributes specified by the application code provider (which could include an individual or entity in the supply chain of the application code range from an application code author to the entity that provides the application code to the management service). The management service might also evaluate the runtime performance of the application. For instance, the management service 212A may perform static analysis of the application 410, and/or review the specification 420 to identify properties of the application, such as dependencies, conditional branching, and so forth. The analysis of the application 410 may also comprise performing dynamic analysis of the application 410 as it runs on the origin data center 501 (e.g., origin data center 211A in the reference example). The management service may also deploy the application in an initial configuration that utilizes one or more edge data centers (e.g., a default deployment configuration) and then measure properties of the deployed configuration. For instance, the management service 212A may evaluate channel properties between the origin data center 501, the edge data center 502, and a client entity 503 of the application 410. These channel properties can include the latency of a message sent between a pair of the entities; the packet loss rate; or the throughput or congestion window achievable. The management service 212A may alternatively or in addition evaluate processing performance of the origin data center 501 and the edge data center 502.

Returning to FIG. 3, the management service then uses an edge data center (act 304) to improve performance of the application in response to evaluating the application. For instance, in the reference example, suppose that the application 410 runs on the origin data center 211A. Suppose further that the management service 212A determines that the application 410 performance may be enhanced by using edge server 211e. Thus, with reference to FIG. 5, the edge data server 502 represents an example of the edge server 211e in the reference example. Examples of how the edge data server 502 may be used to enhance the performance of the application 410 running on the origin data server 501 will now be described with respect to FIGS. 6 through 8.

FIG. 6 illustrates an environment 600 that is similar to the environment 500 of FIG. 5, except that component 411D of application 410 is operating at the edge data center 502, instead of at the origin data center 501. In response to the evaluation of the application 410, the management service 212A determined that the application 410 could perform better if the component 411D were running on the edge data center 502 as compared to the origin data center 501. For instance, perhaps during the evaluation, the management service 212A noticed that there was a lot of data being communicated communication between the client entity 503 and the component 411D, but relatively little data communicated between the component 411D and the remainder of the application 410. Suppose further that the management service 212A noticed that the components 410A through 410C were much more demanding on processing and storage capacity. In this case, if the channel 512 were less expensive and more efficient for communicating with the client entity 503, and the origin data center 501 had much more processing and storage resources available, then the management service 212A could significantly improve performance of the application 410 by offloading component 411D to edge data center 502.

FIG. 7 illustrates an environment 700 that is similar to the environment 500 of FIG. 5, except that application data 702 is present within a cache 701 at the edge data center 502. Here, the edge data center 502 acts is a cache for the application data 702. For instance, suppose that application data that would otherwise be present on the origin data center 501 is frequently sent to the client entity 503. In that case, the application data may be held at the edge data server 502 where it may be more efficiently dispatched to the client entity 503. Alternatively or in addition, suppose that application data that would otherwise be present on the client entity 503 is frequently sent to the origin data center 501. In that case, the application data may be held at the edge data server 502 where it may be more efficiently dispatched to the origin data center 502. Thus, as FIGS. 6 and 7 illustrate, the performance of the application 410 may be enhanced by offloading application code and/or application data to the edge data center 502.

FIG. 8 illustrates an environment 800 that is similar to the environment 500 of FIG. 5, except that enhancement component 801 is operating on the edge data center 502. This enhancement component 801 is executable code that is value-add to the functionality of the application 410 from the perspective of the client entity 503. Examples of such additional functionality could be 1) protocol translation, 2) compression functionality, 3) encryption functionality, 4) authentication functionality, 5) load balancing functionality, and any other function that performs additional functions that enhance the functionality of the application 410 from the perspective of the client entity 503. Each of these five examples of additional functionality will be described hereinafter.

In protocol translation, the application 410 is capable of interfacing over the channel 511 using a first set of protocols, whereas the client 503A is capable of interfacing over the channel 512 using a second set of protocols. Should the client entity 503 communicate over channel 512 using one of the second set of protocols that is not also in the first set of protocols, the component 801 performs protocol translation of the protocol from channel 512 into one of the first set of protocols for communication with the application 410 over channel 511. Thus, the component 801 may perform protocol translation allowing the application 410 to interface with client entities 503 that are not capable of directly interfacing with the application 410.

In compression functionality, the component 801 extracts compressed communications received from the application 410 over channel 511 or the client entity 503 over channel 512. Alternatively or in addition, the component 801 compresses communications transmitted to the application 410 over channel 511 or to the client entity 503 over channel 512. Thus, the component 801 may perform compression and/or extraction on behalf of the application 410 or the client entity 503.

In encryption functionality, the component 801 decrypts communications received from the application 410 over the channel 511 or the client entity 503 over the channel 512. Alternatively or in addition, the component 801 encrypts communications transmitted to the application 410 over channel 511, or to the client entity 503 over channel 512. Thus, the component 801 may perform encryption and/or decryption on behalf of the application 410 or the client entity 503.

In authentication functionality, the component 801 authenticates the client entity 503 or a third party to the application 410, or authenticates the application 410 or a third party to the client entity 503 of the application.

In load balancing functionality, the component 801 handles application requests associated with the application instead of the origin data server depending on a workload of the origin data server. For instance, if the application request would normally be handled by the origin data server 211A, but that origin data server is busy, the edge data server 502 may reroute that application request to another origin data server, or another edge data server.

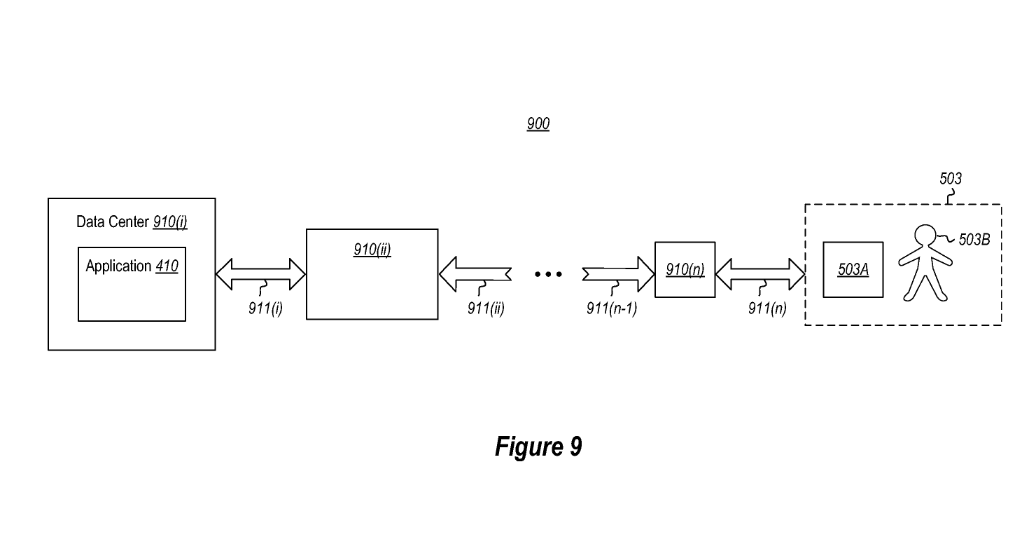

FIGS. 5 through 8 illustrate an example in which there are two tiers of data centers involved in executing or enhancing performance of the application, a larger origin data center 501, and a smaller edge data 502. However, FIG. 9 illustrates that the broader principles described herein are not limited to a two tier structure of data centers, but could be applied to any n-tier structure of data centers, where “n” is an integer that can also be greater than two.

For instance, FIG. 9 illustrates an environment 900 that includes an origin data center 910(i), a second tier data center 910(ii), all the way to an “n”th tier data center 910(n), there may be zero or more intermediary data centers between the second tier data center 910(ii) and the “n”th tier data center 910(n). The “n”th tier data center 910(n) may be considered as an edge data center since it interfaces with the client entity 503. The origin data center 910(i) host the application 410, with the management component offloading code and/or application data to data centers 910(ii) through 910(n), and/or enhancing functionality of the application 410 with components running on the data centers 910(ii) through 910(n).

Origin data center 910(i) communicates with second tier data center 910(ii) using channel 911(i). Second tier data center 910(ii) communicates the next tier data center (data center 910(n) if “n” equals three, or 910(iii) (not shown) if “n” is greater than three) over channel 911(ii). This continues until the “n”th tier data center 910(n) communicates with the prior tier data center (data center 910(ii) if “n” equals three, or 910(n−1) (not shown) if “n” is greater than three) over channel 911(n−1). Mathematically stated, data center 910(k) communicates with the next tier data center 910(k+1) over channel 911(k), where “k” is any integer from 1 to n−1, inclusive. The “n′”th tier data center 910(n) communicates with client entity 503 over channel 911(n). In this example, the data centers become progressive smaller leading from the origin data center 910(i) to the edge data center 910(n)

Thus, a management service is described that operates in a cloud computing environment that allows an application to be hosted by an origin data center, while improving performance of the application using higher tier or edge data center.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A cloud computing environment comprising:
a plurality of data centers, including at least one origin data center and at least one edge data center; and
a management service configured to perform the following in response to receiving a request for the cloud computing environment to host an application:
allocate the application to run on an origin data center of the plurality of data centers;
evaluate the application by evaluating at least one application property specified by a provider of application code corresponding to the application or evaluating runtime performance of the application; and
use an edge server of the plurality of data centers in order to improve performance of the application in response to evaluating the application.

2. The cloud computing environment of claim 1, wherein using the edge server to improve performance of the application comprises allocating a portion of code corresponding to the application to run on the edge data center.

3. The cloud computing environment of claim 1, wherein using the edge server to improve performance of the application comprises having at least a portion of application data cached at the edge data center.

4. The cloud computing environment of claim 1, wherein using the edge server to improve performance of the application comprises causing the edge data center to add functionality to the application.

5. The cloud computing environment of claim 4, wherein the added functionality of the edge data center is protocol translation between client computing systems and the application running on the origin data center.

6. The cloud computing environment of claim 4, wherein the added functionality of the edge data center is compression functionality in which the edge data center extracts compressed communications received from at least one of the application or a client entity of the application, and in which the edge data center compresses communications transmitted to at least one of the application or a client entity of the application.

7. The cloud computing environment of claim 4, wherein the added functionality of the edge data center is encryption functionality in which the edge data center decrypts communications received from at least one of the application or a client entity of the application, and in which the edge data center encrypts communications transmitted to at least one of the application or a client entity of the application.

8. The cloud computing environment of claim 4, wherein the added functionality of the edge data center is authentication functionality in which the edge data center authenticates at least one of a client entity of the application or a third party on behalf of the application, or in which the data center authenticates the application or a third party on behalf of the client entity of the application.

9. The cloud computing environment of claim 4, wherein the added functionality of the edge data center is load balancing functionality in which the edge data center has a different edge server handle application requests associated with the application instead of the origin data server depending on a workload of the origin data server.

10. The cloud computing environment of claim 1, wherein a number of edge data centers in the cloud computing environment is larger than the number of origin data centers in the cloud computing environment.

11. In a cloud computing environment that includes a plurality of data centers, a method for a computer-implemented service to allocate an application between an origin data center and an edge data center, the method comprising:
in response to receiving a request for the cloud computing environment to host an application, allocating the application to run on an origin data center of the plurality of data centers;
evaluating the application by evaluating at least one application property specified by a provider of application code corresponding to the application or evaluating runtime performance of the application; and
using an edge server of the plurality of data centers in order to improve performance of the application in response to evaluating the application.

12. The method in accordance with claim 11, wherein the evaluating of the application comprises evaluating a specification for the application.

13. The method in accordance with claim 11, wherein the evaluating of the application comprises evaluating channel properties between the origin data center, the edge data center, and a client entity of the application.

14. The method in accordance with claim 11, wherein the evaluating of the application comprises evaluating processing performance of the origin data center and the edge data center.

15. The method in accordance with claim 11, wherein using the edge server to improve performance of the application comprises allocating a portion of code corresponding to the application to run on the edge data center.

16. The method in accordance with claim 11, wherein using the edge server to improve performance of the application comprises having at least a portion of application data cached at the edge data center.

17. The method in accordance with claim 11, wherein using the edge server to improve performance of the application comprises causing the edge data center to add functionality to the application.

18. The method in accordance with claim 17, wherein the added functionality of the edge data center is protocol translation between client computing systems and the application running on the origin data center.

19. The method in accordance with claim 17, wherein the added functionality of the edge data center is selected from the group consisting of:
compression functionality in which the edge data center extracts compressed communications received from at least one of the application or a client entity of the application, and in which the edge data center compresses communications transmitted to at least one of the application or a client entity of the application;
encryption functionality in which the edge data center decrypts communications received from at least one of the application or a client entity of the application, and in which the edge data center encrypts communications transmitted to at least one of the application or a client entity of the application;
authentication functionality in which the edge data center authenticates at least one of a client entity of the application or a third party on behalf of the application, or in which the data center authenticates the application or a third party on behalf of the client entity of the application;
load balancing functionality in which the edge data center has a different edge server handle application requests associated with the application instead of the origin data server depending on a workload of the origin data server.

20. In a cloud computing environment that includes a plurality of data centers, a method for a computer-implemented service to allocate an application between an origin data center and an edge data center, the method comprising:
in response to receiving a request for the cloud computing environment to host an application, allocating the application to run on an origin data center of the plurality of data centers;
evaluating the application by evaluating at least one of the application property specified by a provider of application code corresponding to the application or evaluating runtime performance of the application; and
using an edge server of the plurality of data centers in order to improve performance of the application in response to evaluating the application, wherein using the edge server comprises:
allocating a portion of code corresponding to the application to run on the edge data center;
having at least a portion of application data cached at the edge data center; and
causing the edge data center to add functionality to the application.
